(19) United States
(12) Patent Application Publication
(10) Pub. No.: US 2026/0276024 A1
(43) Pub. Date: Sep. 17, 2026

(54) QUICK INSTALL NUT

(71) Applicant: Globe Union Industrial Corp., Taichung City (TW)

(72) Inventor: Hsin-Jen Wang, Taichung City (TW)

(21) Appl. No.: 19/558,500

(22) Filed: Mar. 6, 2026

(30) Foreign Application Priority Data
Mar. 11, 2025 (CN) 202520414824.7

(51) Int. Cl. F16B 37/08

(52) U.S. Cl. CPC F16B 37/0814

(57) ABSTRACT

A quick install nut having a main body and a movable member is provided. The main body includes a sleeve-like first threaded portion having an inner surface provided with a first internal thread. The movable member is pivotally connected to the main body and rotatable between an open position and a closed position. A second internal thread is formed at an inner surface of a second threaded portion of the movable member. When the movable member is in the open position, a resisting surface of the movable portion is at a higher level than a tightening surface of the main body and the second internal thread is away from the first internal thread. Thus a threaded fastener can be quickly inserted through a space between the first and the second internal threads. In the closed position, the first and the second internal threads are engaged with the threaded fastener.

### FIELD OF THE INVENTION

The preset invention relates to a nut, especially to a quick install nut able to be installed and operated quickly.

### BACKGROUND OF THE INVENTION

In many devices, equipment, or accessories, threaded fasteners with long threads including threaded rods, bolts, and threaded pipes are needed and often used in combination with nuts for threaded fastening. In many cases, the nut needs to be rotated and moved a long distance along the threaded fastener for fastening. This gives rise to some problems such as long threading time and low installation and operational efficiency. A limited installation and operation space goes against the rotation of the nut on the threaded fastener. And a force for rotating the nut is even difficult to be applied to the nut and fastening firmness is even affected.

In order to overcome shortcomings of the conventional nut mentioned above, a quick tightening nut is provided in Pub. No. CN 206738362 U. The nut includes a nut body provided with a threaded hole and a through hole. An axis of the threaded hole is vertical while an axis of the through hole is tilted. The axis of the threaded hole and the axis of the through hole are co-planar and an angle between them is an acute angle. A part of threads in the threaded hole is removed by the design of the through hole. While in use, a threaded rod is allowed to insert through the through hole and hold in place quickly after the threaded hole being tilted. Then the nut is returned to its original position and the nut body is fastened on the threaded rod through the threaded hole. Thereby the nut is installed quickly.

However, the above design of the nut still has certain shortcomings. For example, the threaded hole is completely enclosed in the nut body so that internal threads on an inner surface of the threaded hole can't be integrally formed by demolding. The complete threaded hole and the internal threads are formed by metal processing first. Then the through hole is formed by drilling to remove a part of the internal threads is remove. Thereby manufacturing of the nut is limited by the metal processing of the internal thread and the through hole and unable to be made from plastic materials by integral molding. The production efficiency of the nut is limited and reduction of production cost including materials is unattainable due to expensive metal materials used.

The nut is designed with the through hole to avoid direct contact with external threads of the threaded rod and allow quick insert of the threaded rod through the through hole. Yet the enclosed design of the through hole limits not only the space for relief of the threaded rod, but also the tilt angle of the nut. When the nut needs to be designed into a long and thin shape. no sufficient space for relief can be provided due to the above enclosed design of the through hole. Thus the external threads of the threaded rod may be in contact with or engaged with the internal threads of the threaded hole even with the maximum tilt angle. This results in that the tilted nut is unable to move on the threaded smoothly and the applications of the nut are significantly limited.

### SUMMARY

Therefore, it is a primary object of the present invention to provide a quick install nut which provides easy, labor-saving, quick and secure installation and fastening. The quick install nut can be applied to installation and fastening of various bathroom fixtures and accessories such as faucets and toilets.

In order to achieve the above object, a quick install nut according to the present invention includes a main body and a movable member.

The main body consists of a first threaded portion in the form of a sleeve and a tightening wall with a tightening surface. The first threaded portion is composed of a first entrance end connected to the tightening wall, a first exit end, and a first threaded slot defined in the first threaded portion. The main body is provided with a first side and a second side opposite to each other. A first internal thread is disposed on a part of an inner surface of the first threaded slot, located at the first side, and distributed in a circumferential direction.

The movable member is pivotally connected to the tightening wall of the main body at the second side and rotatable between an open position and a closed position. The movable member consists of a second threaded portion in the form of a curved block and a resisting wall provided with a resisting surface. The second threaded portion is provided with a second entrance end connected to the resisting wall, a second exit end, a second threaded slot defined in the second threaded portion, and a second internal thread which is formed at a part of an inner surface of the second threaded slot, located opposite to the first internal thread, and distributed in a circumferential direction. When the movable member is in the open position, the resisting surface is at a level higher than a level of the tightening surface of the main body and the second internal thread is swinging away from the first internal thread so that a threaded fastener in disengaged state is allowed to be quickly inserted through a space between the first internal thread and the second internal thread axially along the main body. The resisting surface of the movable member is able to be pressed so that the movable member is pivotally rotated from the open position to the closed position. At the same time, the second internal thread is forced to swing toward the first internal thread. Thus both the first internal thread and the second internal thread are simultaneously engaged with an external thread of the threaded fastener.

Preferably, at least two lug portions able to be pushed for rotation of the main body are disposed on the main body and projecting from an outer surface of the main body of the quick install nut.

Preferably, the lug portion of the quick install nut is connected to an outer peripheral wall of the first threaded portion and the tightening wall.

Preferably, in the main body of the quick install nut, the first threaded portion and the tightening wall are respectively provided with a lower notch and an upper notch which are both located at the second side. Each of two lateral sides of the tightening surface of the tightening wall adjacent to the upper notch is provided with a positioning slot. A limit groove is disposed on one end side of the positioning slot away from the upper notch. A positioning pin is projecting from and disposed on each of two lateral sides of the resisting wall of the movable member and able to be mounted in and pivotally connected to the corresponding positioning slot. A rear end of the positioning pin is provided with a projecting limit block which is inserted into the corresponding limit groove for limiting the movable member and preventing the movable member from releasing from the main body.

Preferably, in the main body of the quick install nut, a limit locking block is projecting from each of two lateral sides of the tightening wall corresponding to the upper notch and provided with a first contact surface and a second contact surface. Each of the two lateral sides of the resisting wall of the movable member is further provided with a projecting elastic locking block which is abutting against the corresponding first contact surface for limiting and positioning the movable member in the open position. The elastic locking block can be elastically sliding over and passed through the relative/corresponding limit locking block to be stopped and limited by the corresponding second contact surface. Thereby the movable member is limited and positioned in the closed position.

Preferably, in the main body of the quick install nut, each of two lateral sides of the first threaded portion corresponding to the lower notch is provided with a projecting stopping block while a mounting slot is disposed on each of two lateral sides of the second threaded portion of the movable member. The two projecting stopping blocks are mounted in and abutting against the two mounting slots correspondingly when the movable member is in the closed position. Thus the movable member is stopped and positioned in the closed position and the positioning pin the movable member is limited, unable to be released from the positioning slot of the main body.

Preferably, in the movable member of the quick install nut, a first upper surface and a second upper surface are formed on the resisting wall of the movable member and combined with each other to define the resisting surface. The first upper surface is used for being pressed and acted upon by a force when the movable member is in the open position while the second upper surface is used for being pressed and acted upon by a force when the movable member is in the closed position.

Preferably, in the main body of the quick install nut, a close cylindrical wall is connected between an outer peripheral wall the first threaded portion and the tightening wall. A part of the close cylindrical wall is located at the lower notch for hiding the second threaded portion of the movable member therebehind.

Preferably, at least two holding surfaces which allows users to rotate and operate are formed on the close cylindrical wall of the quick install nut.

Preferably, in the main body of the quick install nut, each of two lateral sides of an inner peripheral wall of the close cylindrical wall corresponding to the lower notch is provided with a limit recess. A limit block is disposed on and projecting from each of two lateral sides of the second threaded portion of the movable member for being mounted and limited in the corresponding limit recess. Thus the movable member is limited to be pivotally rotated between the open position and the closed position.

Preferably, a holding cylindrical wall is extended from the first exit end of the first threaded portion axially along the main body and a holding surface able to be held and rotated is formed on an outer surface of the holding cylindrical wall.

Preferably, an annular recess is mounted to the tightening wall of the main body and a tightening washer is mounted in the annular recess. The tightening surface is defined on an outer surface of the tightening washer. The annular recess is provided with two positioning grooves disposed on two lateral sides of the second side correspondingly. A positioning pin is projecting from each of two lateral sides of the resisting wall of the movable member and is mounted in and pivotally connected to the corresponding positioning groove.

Preferably, a positioning mounting recess is formed on the first threaded portion and the tightening wall and located at the second side of the main body for mounting the second threaded portion of the movable member. The tightening washer is provided with a cut edge corresponding to the second side of the main body and an opening is defined by one side of the positioning mounting recess corresponding to the first entrance end together with the cut edge and used for allowing the movable member to insert therein.

Preferably, each of two lateral sides of a bottom wall surface of the annular recess of the main body is provided with a nut positioning groove and an insertion hole is penetrating a bottom surface of the nut positioning groove axially along the main body. Two nuts are mounted and positioned in the nut positioning grooves correspondingly and rotation of the nuts is limited. A threaded hole is formed in each of the nuts. Two tightening bolts are inserted through the insertion holes from the first exit end to the first entrance end of the main body to be threaded in the threaded holes correspondingly. Thus the tightening washer is abutted against by the tightening bolts.

Preferably, in the main body of the quick install nut, a threaded hole is penetrating each of the two lateral sides of the bottom wall surface of the annular recess of the main body axially along the main body and the tightening bolts are inserted through the corresponding threaded holes from the first exit end to the first entrance end of the main body to be threaded in the threaded holes. Thereby the tightening washer is abutted against by the tightening bolts.

Preferably, the movable member of the quick install nut is pivotally rotated and positioned in the open position by a weight of the movable member itself under normal conditions.

Preferably, the movable member of the nut is in the open position under normal conditions. Thus the installers can directly fit the nut around and move quickly on the threaded fastener until the resisting surface of the movable members is pressed on, without tilting the nut. Then the nut is automatically rotated to the closed position and both the first internal thread in the main body and the second internal thread in the movable member are engaged with the threaded fastener quickly. Thereby the installer only need to rotate the nut a little bit to achieve tightening and fastening effects. Therefore, the assembly and operation are simple, fast, and secure, especially able to be performed with a single hand.

There is no need to tilt the nut during installation so that the nut is suitable for installation and fastening of various bathroom fixtures and accessories including faucets and toilets. Not only time required for thread engagement of long threads is significantly shortened and ease of installation and operation is improved, reliable and durable fastening is also achieved.

Instead of integrally formed component, the nut is an assembly of the main body with the movable member which are made of plastic material and produced by molding. Thus manufacturing is easy and quick and lightweighting is also achieved.

The nut is designed to have structure easy to be held and operated by the installer. For example, such structure can be the lug portion, the holding surface of the close cylindrical wall, and the holding surface of the holding cylindrical wall. Therefore, the nut is easy to hold and rotate and labor-saving operation is also achieved.

### BRIEF DESCRIPTION OF THE DRAWINGS

FIG. 1 is a perspective view of an embodiment of a nut in an open position according to the present invention;

FIG. 2 is a top planar view of the embodiment in FIG. 1 according to the present invention;

FIG. 3 is a sectional view taken along line 1-1 of the embodiment in FIG. 2 according to the present invention;

FIG. 4 is a sectional view taken along line 2-2 of the embodiment in FIG. 2 according to the present invention;

FIG. 5 is an exploded view of an embodiment of a nut according to the present invention;

FIG. 6 is a perspective bottom view of a main body in an embodiment according to the present invention;

FIG. 7 is a perspective view of a movable member in an embodiment of according to the present invention;

FIG. 8 is a perspective view of an embodiment of a nut in a closed position according to the present invention;

FIG. 9 is a longitudinal section of a main body and a middle part of a movable member of the embodiment in FIG. 8 according to the present invention;

FIG. 10 is a partially exploded sectional view of an embodiment applied to a first object and a second object according to the present invention;

FIG. 11 is a perspective view of another embodiment of a nut in an open position according to the present invention;

FIG. 12 is a longitudinal section of a main body and a middle part of a movable member of the embodiment in FIG. 11 according to the present invention;

FIG. 13 is an exploded view of another embodiment of a nut according to the present invention;

FIG. 14 is a longitudinal section of a movable member of the embodiment in FIG. 12 in a closed position according to the present invention;

FIG. 15 is a perspective view of a further embodiment of a nut in a closed position according to the present invention;

FIG. 16 is a top planar view of the embodiment in FIG. 15 according to the present invention;

FIG. 17 is an exploded view of a further embodiment of a nut according to the present invention;

FIG. 18 is a sectional view taken along line 3-3 of the embodiment in FIG. 16 according to the present invention;

FIG. 19 is a sectional view taken along line 4-4 of the embodiment in FIG. 16 according to the present invention;

FIG. 20 is a longitudinal section of a movable member of the embodiment in FIG. 18 in an open position according to the present invention.

### DETAILED DESCRIPTION

Please refer to the following embodiments and related figures.

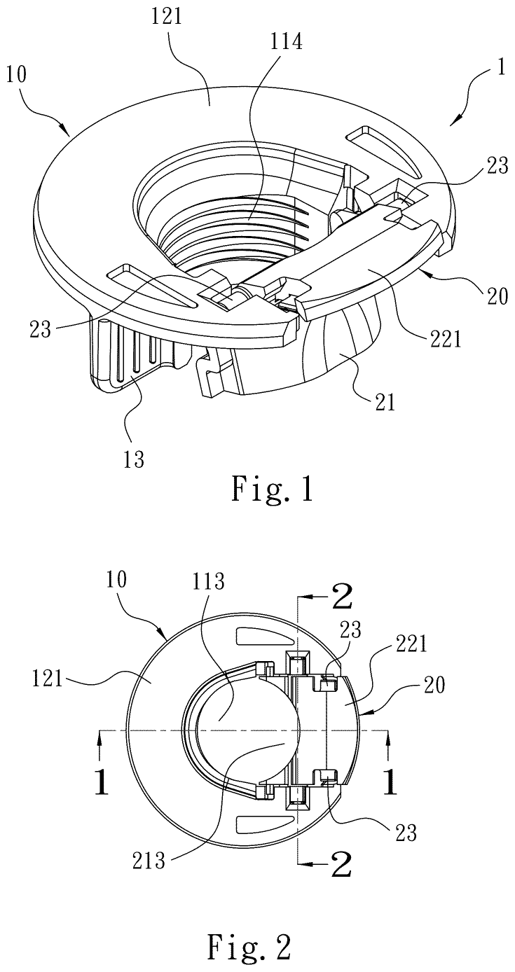

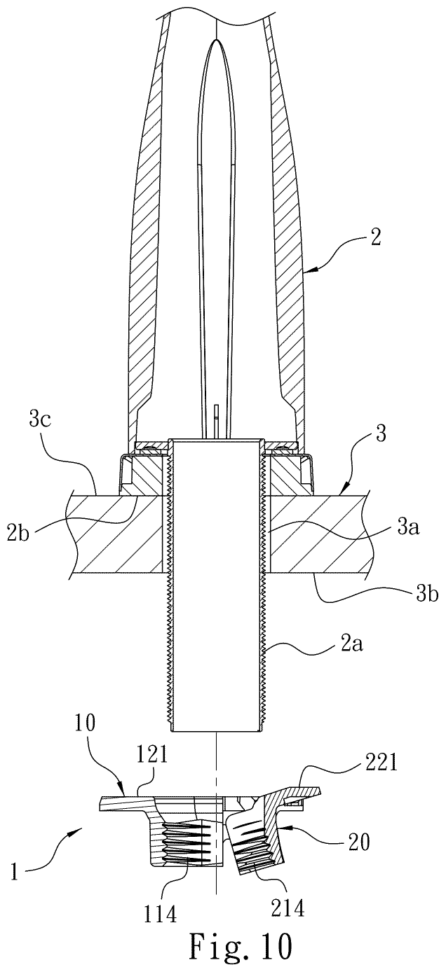

Refer to FIG. 1-5, a quick install nut 1 according to the present invention is used to be threaded onto a threaded fastener such as bolt, threaded rod, and threaded pipe in different forms for joining two objects or fastening the two objects on a third object quickly. As shown in FIG. 10, a first object 2 is provided with a threaded rod 2a on a bottom end. A second objects 3 has at least one installation hole 3a for allowing the threaded rod 2a to insert through from top to bottom. The nut 1 is quickly fit and threaded onto the threaded rod 2a and then not only abutting against a lower surface 3b of the second objects 3, but also forcing a lower surface 2b of the first object 2 to abut against and fix on an upper surface 3c of the second object 3 at the same time. Thereby the first object 2 is threaded and fastened onto the second object 3 quickly.

The first object 2 can be various faucet parts in different forms with at least one threaded rod 2a on the bottom thereof. The second object 3 is a common countertop around sinks or bathtubs and usually provided with at least one installation hole 3a.

In this embodiment, the nut 1 includes a main body 10 and a movable member 20.

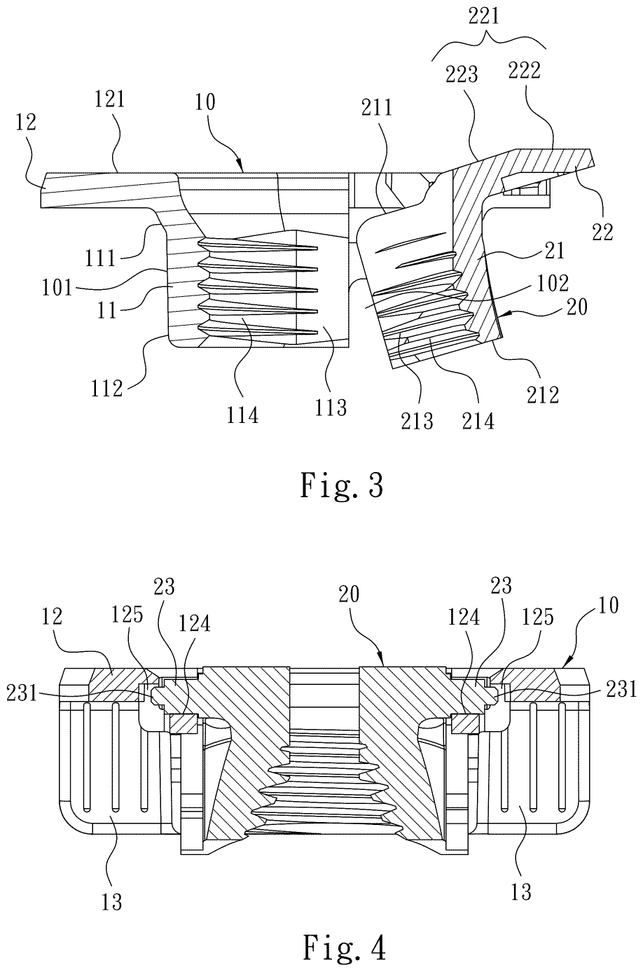

As shown in FIG. 3-6, the main body 10 consists of a first threaded portion 11 in the form of a sleeve and a tightening wall 12 with a tightening surface 121. The first threaded portion 11 is composed of a first entrance end 111 connected to the tightening wall 12, a first exit end 112, and a first threaded slot 113 defined in the first threaded portion 11. The main body 10 is provided with a first side 101 and a second side 102 opposite to each other. As shown in FIG. 3, a first internal thread 114 is formed at a part of an inner surface of the first threaded slot 113, located at the first side 101, and distributed in a circumferential direction.

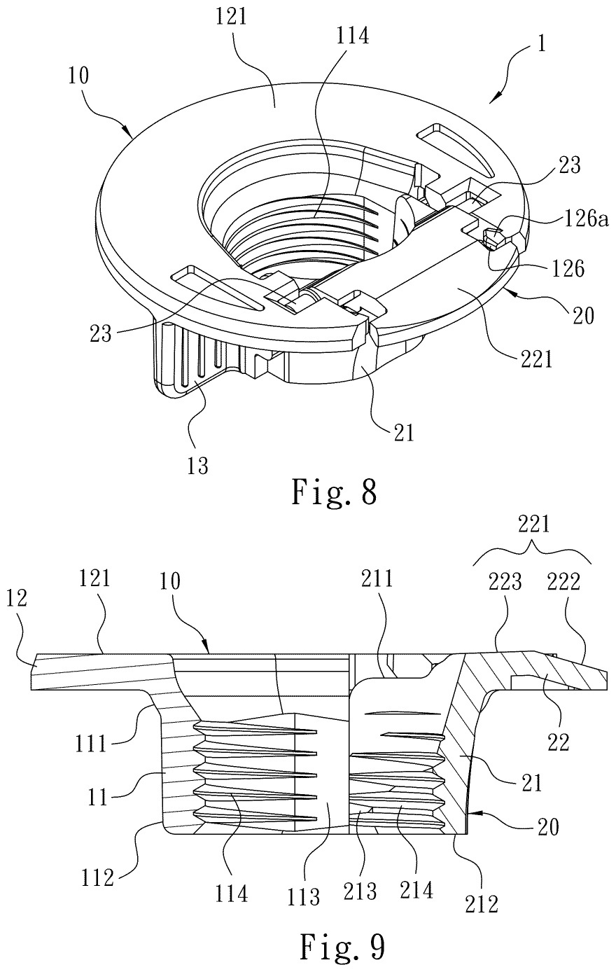

As shown in FIG. 7, the movable member 20 is pivotally connected to the tightening wall 12 of the main body 10 at the second side 102 and rotatable between an open position and a closed position. The movable member 20 is composed of a second threaded portion 21 in the form of a curved block and a resisting wall 22 provided with a resisting surface 221. The second threaded portion 21 is provided with a second entrance end 211 connected to the resisting wall 22, a second exit end 212, a second threaded slot 213 defined in the second threaded portion 21, and a second internal thread 214. The second internal thread 214 is formed at a part of an inner surface of the second threaded slot 213, located opposite to the first internal thread 114, and distributed in a circumferential direction. Refer to FIG. 3, when the movable member 20 is in the open position, the resisting surface 221 is at a level higher than a level of the tightening surface 121 of the main body 10 and the second internal thread 214 is swinging away from the first internal thread 114 so that the threaded rod 2a in a disengaged state is allowed to be quickly inserted through a space between the first internal thread 114 and the second internal thread 214 axially along the main body 10. Then the resisting surface 221 of the movable member 20 is pressed. For example, the resisting surface 221 of the movable member 20 is pressed against by the lower surface 3b of the second objects 3 so that the movable member 20 is pivotally rotated from the open position to the closed position, as shown in FIG. 8 and FIG. 9. At the same time, the second internal thread 214 is forced to swing toward the first internal thread 114. Thus both the first internal thread 114 and the second internal thread 214 are simultaneously engaged with an external thread of the threaded rod 2a. At the moment, installers only need to turn the main body 10 a little bit in a tightening direction so that the resisting surface 221 of the movable member 20 is abutting against and pressed on the lower surface 3b of the second objects 3. And the lower surface 2b of the first object 2 is also forced to abut against and press on the upper surface 3c of the second objects 3 at the same time. Thereby the first object 2 is fastened on the second object 3 quickly and securely.

It is easy to understand that while the movable member 20 being pressed against in the open position and pivotally rotated to the closed position, the level of the resisting surface 221 is not exceeding the level of the tightening surface 121 of the main body 10, or just flush with the level of the tightening surface 121.

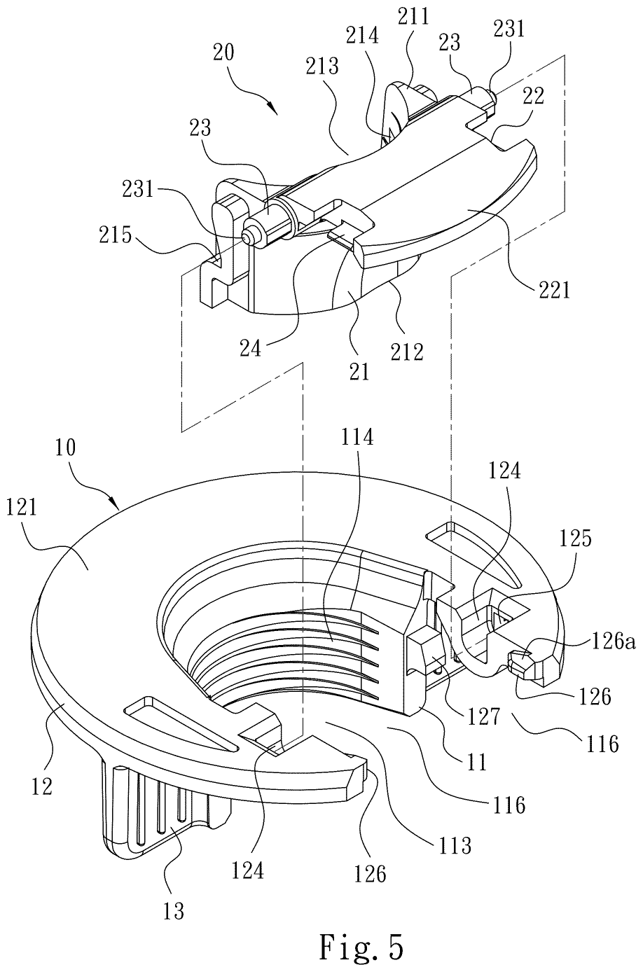

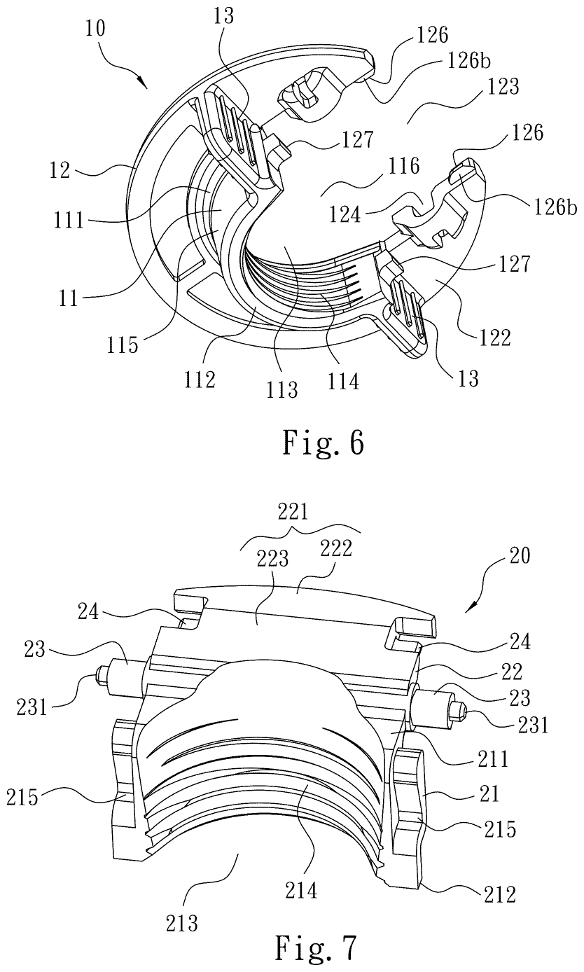

In this embodiment, as shown in FIG. 5 and FIG. 6, at least two lug portions 13 able to be pushed for turning the main body 10 are disposed on the main body 10 and projecting from an outer surface of the main body 10. In an embodiment, the lug portion 13 is connected to an outer peripheral wall of the first threaded portion 11 and a corresponding position of the tightening wall 12 such as a lower wall surface 122.

Still refer to FIG. 5 and FIG. 6, the first threaded portion 11 and the tightening wall 12 of the main body 10 are respectively provided with a lower notch 116 and an upper notch 123 which are both located at the second side 102. Each of two lateral sides of the tightening surface 121 of the tightening wall 12 adjacent to the upper notch 123 is provided with a positioning slot 124. A limit groove 125 is disposed on one end side of the positioning slot 124 away from the upper notch 123. A positioning pin 23 is projecting from and disposed on each of two lateral sides of the resisting wall 22 of the movable member 20 and able to be mounted in and pivotally connected to the corresponding positioning slot 124. A rear end of the positioning pin 23 is provided with a projecting limit block 231 which is inserted into the corresponding limit groove 125 for limiting and preventing the movable member 20 from releasing from the main body 10 and ensuring stable and smooth pivoting movement of the movable member 20 on the main body 10.

A limit locking block 126 is projecting from each of two lateral sides of the tightening wall 12 of the main body 10 corresponding to the upper notch 123 and provided with a first contact surface 126a and a second contact surface 126b, as shown in FIG. 5 and FIG. 6. Refer to FIG. 7, each of the two lateral sides of the resisting wall 22 of the movable member 20 is further provided with a projecting elastic locking block 24 which is abutting against the corresponding first contact surface 126a for limiting and positioning the movable member 20 in the open position. The elastic locking block 24 can be elastically sliding over and passed through the corresponding limit locking block 126 to be stopped and limited by the corresponding second contact surface 126b. Thereby the movable member 20 is limited and positioned in the closed position.

As shown in FIG. 5 and FIG. 7, each of two lateral sides of the first threaded portion 11 of the main body 10 relative to the lower notch 116 is provided with a projecting stopping block 127 while a mounting slot 215 is disposed on each of two lateral sides of the second threaded portion 21 of the movable member 20. When the movable member 20 is in the closed position, the two stopping blocks 127 are mounted in and abutting against the two mounting slots 215 correspondingly. Thus the movable member 20 is stopped and positioned in the closed position and the positioning pin 23 of the movable member 20 is also limited, without being released from the positioning slot 124 of the main body 10. It is learned that two technical features are used in this embodiment to prevent the movable member 20 from releasing from the main body 10. One feature is that the projecting limit block 231 of the positioning pin 23 of the movable member 20 is inserted and positioned in the corresponding limit groove 125 on an outer side of the positioning slot 124 of the main body 10. The other feature is the mounting slot 215 of the movable member 20 used for allowing the stopping block 127 of the main body 10 to be mounted and abutting against therein.

In this embodiment, a first upper surface 222 and a second upper surface 223 are formed on the resisting wall 22 of the movable member 20 and combined with each other to define the resisting surface 221. The first upper surface 222 is used for being pressed and acted upon by a force when the movable member 20 is in the open position while the second upper surface 223 is used for being pressed and acted upon by a force when the movable member 20 is in the closed position. It should be understood that the resisting surface 221 can be in other forms, not limited in the form composed of the first upper surface 222 and the second upper surface 223 mentioned above.

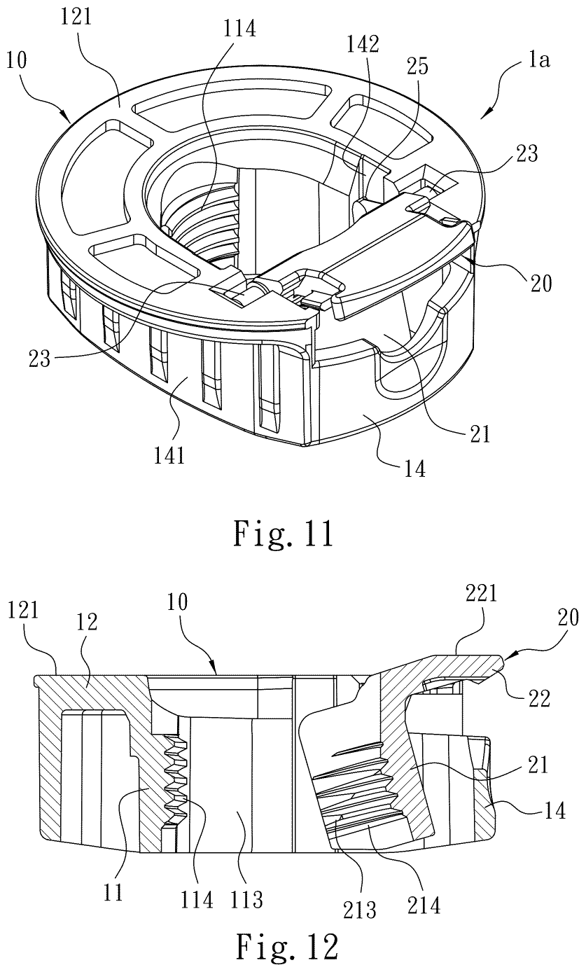

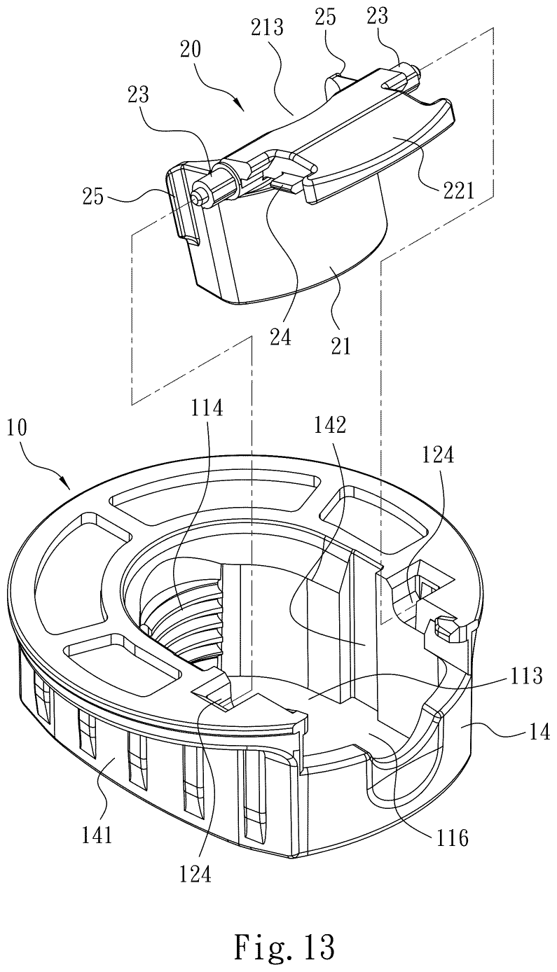

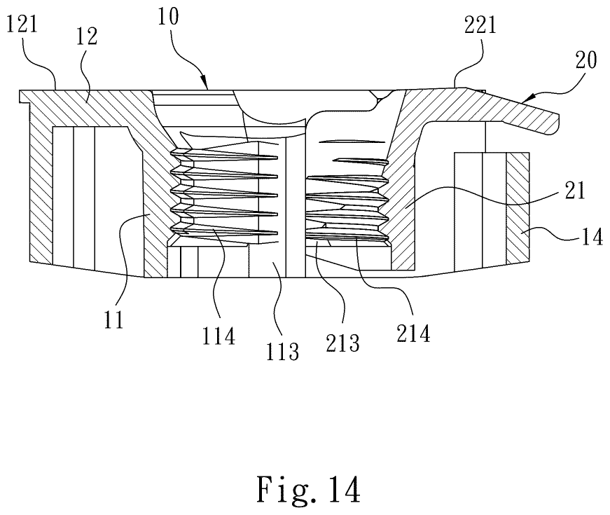

As shown in FIG. 11-14, another embodiment of a quick install nut is provided. A nut 1a of this embodiment is about the same as the nut 1 of the above embodiment. The difference between the nut 1a and the nut 1 is as described below.

A close cylindrical wall 14 is connected between an outer peripheral wall of the first threaded portion 11 of the main body 10 and the tightening wall 12. A part of the close cylindrical wall 14 is located at the lower notch 116 for hiding the second threaded portion 21 of the movable member 20 therebehind. The above design prevents installers from contacting with or carelessly moving the movable part 20 while rotating and operating the nut 10.

At least two holding surfaces 141 which allows users to rotate and operate are formed on the close cylindrical wall 14. Compared with the lug portion 13 of the first embodiment, the holding surface 141 of the close cylindrical wall 14 provides an easier hold, operation, and force application.

Each of two lateral sides of an inner peripheral wall of the close cylindrical wall 14 of the main body 10 corresponding to the lower notch 116 is provided with a limit recess 142. A limit block 25 is disposed on and projecting from each of two lateral sides of the second threaded portion 21 of the movable member 20 for being mounted and limited in the corresponding limit recess 142. Thereby the movable member 20 is limited and pivotally rotated between the open position and the closed position.

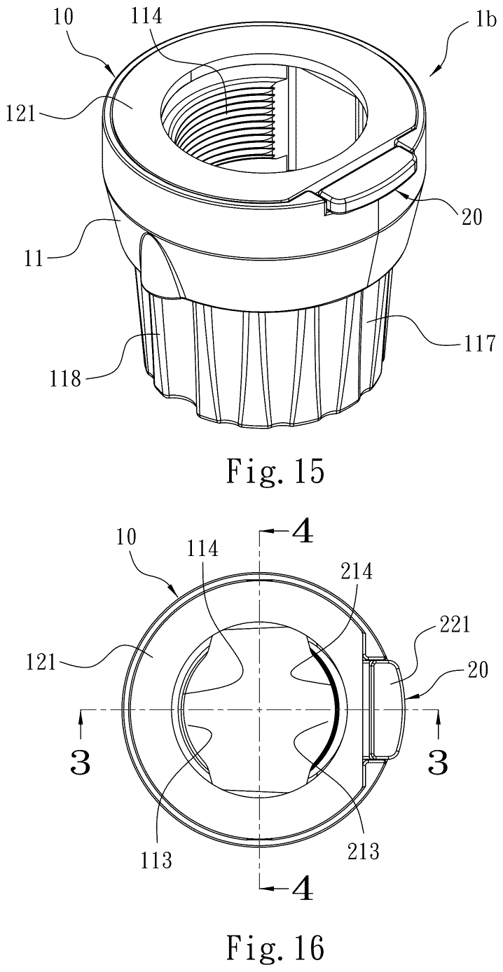

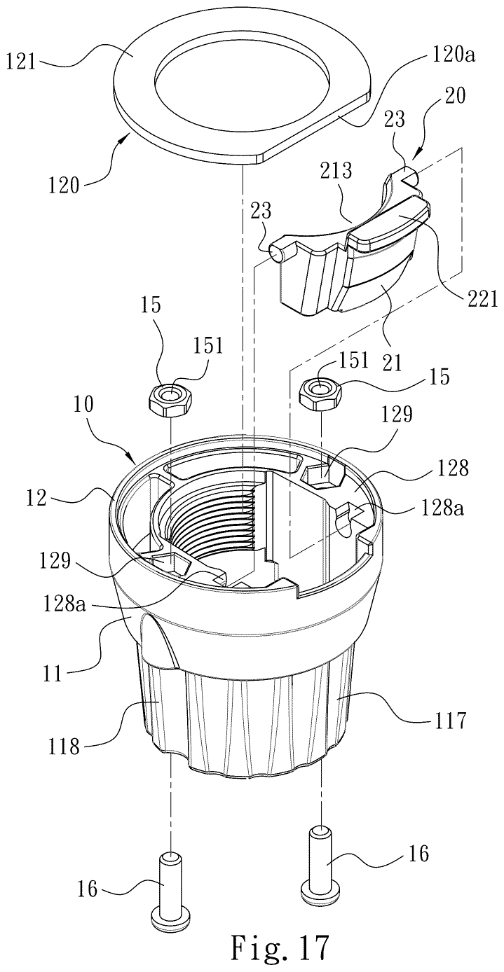

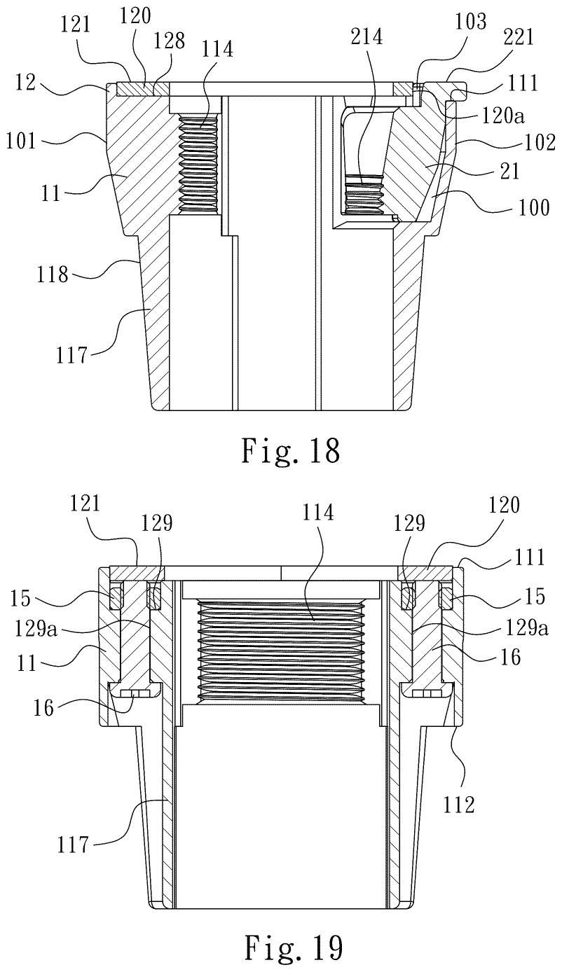

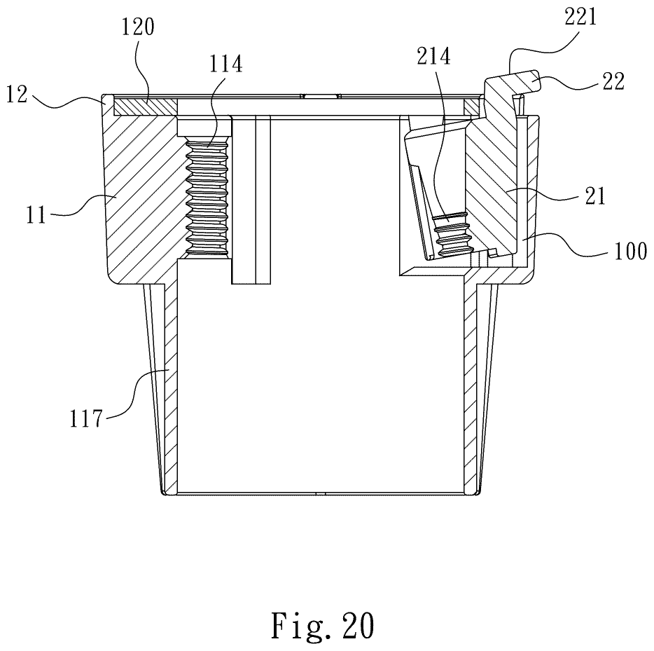

As shown in FIG. 15-20, a further embodiment of a quick install nut is provided. A nut 1b of this embodiment is about the same as the nut 1 of the first embodiment. The difference between the nut 1a and the nut 1 is described below.

A holding cylindrical wall 117 is extended from the first exit end 112 of the first threaded portion 11 of the main body 10 axially along the main body 10 and a holding surface 118 used for allowing users to hold and rotate is formed on an outer surface of the holding cylindrical wall 117.

An annular recess 128 is mounted to the tightening wall 12 of the main body 10 and a tightening washer 120 is mounted in the annular recess 128. The tightening surface 121 is defined on an outer surface of the tightening washer 120. A positioning groove 128a is disposed on each of two lateral sides of the annular recess 128 corresponding to the second side 102. The positioning pins 23 on the resisting wall 22 of the movable member 20 are mounted in and pivotally connected to the positioning grooves 128a correspondingly.

A positioning mounting recess 100 is formed on the first threaded portion 11 and the tightening wall 12 and located at the second side 102 of the main body 10 for mounting the second threaded portion 21 of the movable member 20. The tightening washer 120 is provided with a cut edge 120a corresponding to the second side 102 of the main body 10. An opening 103 is defined by one side of the positioning mounting recess 100 corresponding to the first entrance end 111 together with the cut edge 120a and used for allowing the movable member 20 to insert therein.

Each of two lateral sides of a bottom wall surface of the annular recess 128 of the main body 10 is provided with a nut positioning groove 129 and an insertion hole 129a is penetrating a bottom surface of the nut positioning groove 129 axially along the main body 10. Two nuts 15 are mounted and positioned in the nut positioning grooves 129 correspondingly and rotation of the nuts 15 is limited. A threaded hole 151 is formed in each of the nuts 15. Two tightening bolts 16 are inserted through the insertion holes 129a from the first exit end 112 to the first entrance end 111 of the main body 10 to be threaded in the threaded holes 151 correspondingly. Thereby the tightening washer 120 is abutted against by the tightening bolts 16. By such tightening effect, not only firmness of thread connection between the nut 1b and the threaded rod 2a is ensured, loosening possibly generated during further use is also avoided.

It is easily understood that in a further embodiment, a threaded hole is directly penetrating each of the two lateral sides of the bottom wall surface of the annular recess 128 of the main body 10 axially along the main body 10 so that the tightening bolts 16 are inserted through the corresponding threaded holes from the first exit end 112 to the first entrance end 111 of the main body 10 to be threaded in the threaded holes. Thereby the tightening washer 120 is also abutted against by the tightening bolts 16.

It should be noted that the movable member 20 in the above embodiments is designed to be pivotally rotated and positioned in the open position a weight of the movable member itself under normal conditions. Such design not only ensures that the movable member 20 is in the open position able to be installed directly before installation, but also helps the following installation and operation.

According to the above embodiments, it is learned that the movable members 20 of the nuts 1, 1a, and 1b are in the open position under normal conditions. Thus the installers can directly fit the nuts 1, 1a, and 1b around a rear end of the threaded rod 2a of the first object 2 and move the nuts 1, 1a, and 1b upward until the resisting surface 221 of the movable members 20 is abutting against the lower surface 3b of the second object 3 and the movable member 20 is pivotally rotated to the closed position automatically, without tilting the nuts 1, 1a, and 1b. Then the first internal thread 114 in the main body 10 and the second internal thread 214 in the movable member 20 of the nuts 1, 1a, and 1b are both engaged with the external thread of the threaded rod 2a quickly. Thereby the installer only need to rotate the nuts 1, 1a, and 1b a little bit more, the tightening and fastening effects are achieved. Therefore, the installation and operation are simple, fast, and secure, especially able to be performed with a single hand.

There is no need to tilt the nuts 1, 1a, and 1b during installation so that the nuts 1, 1a, and 1b are suitable for installation and fastening of various bathroom fixtures and accessories including faucets and toilets. Not only time required for thread engagement of long threads is significantly shortened and ease of installation and operation is improved, reliable and durable fastening is also achieved.

Moreover, instead of integrally formed components, the nuts 1, 1a, and 1b are an assembly of the main body 10 with the movable member 20 which are made of plastic material and produced by molding. Thus manufacturing is easy and quick, and lightweighting is also achieved. The nuts 1, 1a, and 1b are designed to have structure easy to be held and operated by the installers. For example, such structure can be the lug portion 13, the holding surface 141 of the close cylindrical wall 14, and the holding surface 118 of the holding cylindrical wall 117. Therefore, the nuts 1, 1a, and 1b are easy to hold and rotate and labor-saving operation is also achieved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A quick install nut comprising:
a main body including a first threaded portion in the form of a sleeve and a tightening wall with a tightening surface; the main body further provided with a first side and a second side opposite to each other; the first threaded portion composed of a first entrance end connected to the tightening wall, a first exit end, a first threaded slot defined in the first threaded portion, and a first internal thread which is disposed on a part of an inner surface of the first threaded slot, located at the first side, and distributed in a circumferential direction; and
a movable member pivotally connected to the tightening wall of the main body at the second side and rotatable between an open position and a closed position; the movable member having a second threaded portion in the form of a curved block and a resisting wall provided with a resisting surface; the second threaded portion provided with a second entrance end connected to the resisting wall, a second exit end, a second threaded slot defined in the second threaded portion, and a second internal thread which is formed at a part of an inner surface of the second threaded slot, located opposite to the first internal thread, and distributed in a circumferential direction;
wherein the resisting surface of the movable member is at a level higher than a level of the tightening surface of the main body and the second internal thread is swinging away from the first internal thread when the movable member is in the open position; thus a threaded fastener in disengaged state is allowed to be quickly inserted through a space between the first internal thread and the second internal thread axially along the main body; the resisting surface of the movable member is pressed so that the movable member is pivotally rotated from the open position to the closed position and the second internal thread is forced to swing toward the first internal thread at the same time; thus both the first internal thread and the second internal thread are engaged with an external thread of the threaded fastener.

2. The quick install nut as claimed in claim 1, wherein at least two lug portions able to be pushed and operated are disposed on the main body and projecting from an outer surface of the main body.

3. The quick install nut as claimed in claim 2, wherein the lug portion is connected to an outer peripheral wall of the first threaded portion and the tightening wall.

4. The quick install nut as claimed in claim 1, wherein the first threaded portion and the tightening wall of the main body are respectively provided with a lower notch and an upper notch which are both located at the second side; each of two lateral sides of the tightening surface of the tightening wall adjacent to the upper notch is provided with a positioning slot; a limit groove is disposed on one end side of the positioning slot away from the upper notch; a positioning pin is projecting from each of two lateral sides of the resisting wall of the movable member, mounted in, and pivotally connected to the corresponding positioning slot; a rear end of the positioning pin is provided with a projecting limit block which is inserted into the corresponding limit groove for limiting the movable member from releasing from the main body.

5. The quick install nut as claimed in claim 4, wherein a limit locking block is projecting from each of two lateral sides of the tightening wall corresponding to the upper notch and provided with a first contact surface and a second contact surface; each of the two lateral sides of the resisting wall of the movable member is further provided with a projecting elastic locking block which is abutting against the corresponding first contact surface for limiting and positioning the movable member in the open position; the elastic locking block is elastically sliding over and passed through the corresponding limit locking block to be stopped and limited by the corresponding second contact surface for limiting and positioning the movable member in the closed position.

6. The quick install nut as claimed in claim 4, wherein each of two lateral sides of the first threaded portion of the main body corresponding to the lower notch is provided with a projecting stopping block while a mounting slot is disposed on each of two lateral sides of the second threaded portion of the movable member; the two projecting stopping blocks are mounted in and abutting against the two mounting slots correspondingly when the movable member is in the closed position; thus the movable member is stopped and positioned in the closed position and the positioning pin of the movable member is limited, unable to be released from the positioning slot of the main body.

7. The quick install nut as claimed in claim 4, wherein a first upper surface and a second upper surface are formed on the resisting wall of the movable member and combined with each other to define the resisting surface; the first upper surface is used for being pressed and acted upon by a force when the movable member is in the open position; the second upper surface is used for being pressed and acted upon by a force when the movable member is in the closed position.

8. The quick install nut as claimed in claim 1, wherein a close cylindrical wall is connected between an outer peripheral wall of the first threaded portion and the tightening wall of the main body; a part of the close cylindrical wall is located at the lower notch for hiding the second threaded portion of the movable member therebehind.

9. The quick install nut as claimed in claim 8, wherein at least two holding surfaces able to be pushed and operated are formed on the close cylindrical wall.

10. The quick install nut as claimed in claim 8, wherein each of two lateral sides of an inner peripheral wall of the close cylindrical wall of the main body corresponding to the lower notch is provided with a limit recess; a limit block is disposed on and projecting from each of two lateral sides of the second threaded portion of the movable member for being mounted and limited in the corresponding limit recess; thereby the movable member is limited to be pivotally rotated between the open position and the closed position.

11. The quick install nut as claimed in claim 1, wherein a holding cylindrical wall is extended from the first exit end of the first threaded portion of the main body axially along the main body and a holding surface able to be held and rotated is formed on an outer surface of the holding cylindrical wall.

12. The quick install nut as claimed in claim 1, wherein an annular recess is mounted to the tightening wall of the main body and a tightening washer is mounted in the annular recess; the tightening surface is defined on an outer surface of the tightening washer; a positioning groove is disposed on each of two lateral sides of the annular recess corresponding to the second side; a positioning pin is projecting from and disposed on each of two lateral sides of the resisting wall of the movable member and is mounted in and pivotally connected to the corresponding positioning groove.

13. The quick install nut as claimed in claim 12, wherein a positioning mounting recess is formed on the first threaded portion and the tightening wall and located at the second side of the main body for mounting the second threaded portion of the movable member; the tightening washer is provided with a cut edge corresponding to the second side of the main body; an opening is defined by one side of the positioning mounting recess corresponding to the first entrance end together with the cut edge and used for allowing the movable member to insert therein.

14. The quick install nut as claimed in claim 12, wherein each of two lateral sides of a bottom wall surface of the annular recess of the main body is provided with a nut positioning groove and an insertion hole is penetrating a bottom surface of the nut positioning groove axially along the main body; two nuts are mounted and positioned in the nut positioning grooves correspondingly and rotation of the nuts is limited; a threaded hole is formed in each of the nuts; two tightening bolts are inserted through the insertion holes from the first exit end to the first entrance end of the main body to be threaded in the threaded holes correspondingly; thus the tightening washer is abutted against by the tightening bolts.

15. The quick install nut as claimed in claim 12, wherein a threaded hole is directly penetrating each of two lateral sides of a bottom wall surface of the annular recess of the main body axially along the main body; two tightening bolts are inserted through the threaded holes from the first exit end to the first entrance end of the main body corresponding to be threaded in the threaded holes; thus the tightening washer is abutted against by the tightening bolts.

16. The quick install nut as claimed in claim 1, wherein the movable member is pivotally rotated and positioned in the open position by a weight of the movable member itself under normal conditions.
